(19) United States
(12) Patent Application Publication
(10) Pub. No.: US 2015/0268665 A1
(43) Pub. Date: Sep. 24, 2015

(54) VEHICLE COMMUNICATION USING AUDIBLE SIGNALS

(71) Applicants: Christopher Ludwick, Mountain View, CA (US); Clifford Ivar Nass, Stanford, CA (US); David I. Ferguson, San Francisco, CA (US)

(72) Inventors: Christopher Ludwick, Mountain View, CA (US); Clifford Ivar Nass, Stanford, CA (US); David I. Ferguson, San Francisco, CA (US)

(73) Assignee: GOOGLE INC., Mountain View, CA (US)

(21) Appl. No.: 14/074,356

(22) Filed: Nov. 7, 2013

(51) Int. Cl. G05D 1/00

(52) U.S. Cl. CPC G05D 1/0055

(57) ABSTRACT

The present disclosure relates to enabling an autonomous vehicle operating in a self-driving mode to communicate information about what the vehicle is about to do or is currently doing. For example, one or more processors may maneuver a vehicle in an autonomous or self-driving mode. While maneuvering the vehicle in the autonomous driving mode, a time when the vehicle will begin to accelerate may be determined. A first audible signal may be played through a speaker at a time t seconds before the time when the vehicle will begin to accelerate. While maneuvering the vehicle in the autonomous driving mode, a time when the vehicle will begin to decelerate may also be determined. A second audible signal, different from the first audible signal, may be played through the speaker at the time when the vehicle begins decelerating.

### BACKGROUND

Autonomous vehicles use various computing systems to aid in the transport of passengers from one location to another. Some autonomous vehicles may require some initial input or continuous input from an operator, such as a pilot, driver, or passenger. Other systems, for example autopilot systems, may be used only when the system has been engaged, which permits the operator to switch from a manual driving mode (where the operator exercises a high degree of control over the movement of the vehicle) to a fully autonomous driving mode (where the vehicle essentially drives itself) to modes that lie somewhere in between.

With traditional vehicles, whether internal combustion engines or electric vehicles it is impossible for the vehicle to communicate the driver's intent. This is because the vehicle cannot know what the driver is planning to do, unless the driver specifically provides this information, such as by activating a turn signal. This may lead to problems for pedestrians, bicyclists, and human drivers of other vehicles (“tertiary users”). In some cases, the driver may initiate visual signals. These may include eye contact (“I see you” or “I'm not looking at you”), hand gestures (e.g., a wave in a particular direction means “you can go ahead of me (others cannot necessarily)”; an upheld hand means “wait”), and head gestures (e.g., a nod for “you can continue to do what you're doing”; a shake for “do not do that”). However, there are many cases in which the driver may not be visible (e.g., night, the slowing vehicle is ahead of the merging vehicle or pedestrian) or the meaning of eye contact and gestures can be ambiguous.

With autonomous vehicles, using the driver as a communicator is difficult and frequently misleading in that the human passenger is not making all of the driving decisions and there may not actually be a human driver. This may create safety challenges with respect to the surrounding world unless this class of vehicles can signal intent to the world around. Of course, this intent should be unambiguous and instantly recognizable.

Some vehicles do provide information about what the vehicle is currently doing. Certain categories of vehicles, such as trucks or other vehicles that have potentially obstructed views, may be required by law to emit a sound when they are operated in reverse. This sound is emitted as soon as the truck is placed in a reverse gear, regardless of whether it is moving or not. Electric vehicles operating at slow speeds do not produce sounds equal to that of an internal combustion engine. As a result, electric vehicles operating under 18 mph may be required by law to emit a sound that is in some ways similar to an internal combustion engine. These vehicles may use different sounds to indicate acceleration, deceleration, constant speed, reverse, and initiating the engine. When a train is about to close its doors when in a stopped position, it may emit a signal (either a voice or beeps). Trains will sometimes emit a sound when they are passing a station or a grade without stopping, stopping at a station, starting to move, planning to go in reverse, and/or traveling at certain speeds. However, these vehicles are not always able to independently, without input from a human driver, communicate what the vehicle will do in the future, and especially where that intent changes quickly.

### BRIEF SUMMARY

One aspect of the disclosure provides a method. The method includes maneuvering a vehicle, by one or more processors, in an autonomous driving mode; while maneuvering the vehicle in the autonomous driving mode, determining, by the one or more processors, a time when the vehicle will begin to accelerate; playing, by the one or more processors, a first audible signal through a speaker at a time t seconds before the time when the vehicle will begin to accelerate; while maneuvering the vehicle in the autonomous driving mode, determining, by the one or more processors, a time when the vehicle will begin to decelerate; and playing, by the one or more processors, through the speaker a second audible signal, different from the first audible signal, at the time when the vehicle begins decelerating.

In one example, the first audible signal includes a sound that mimics sounds of an internal combustion engine accelerating. In another example, the first audible signal includes a sound which mimics sounds of a hybrid vehicle engine accelerating. In another example, the audible signal includes a sound that mimics sounds of an internal combustion engine decelerating. In another example, the method also includes determining a time when the vehicle will accelerate from a parked position; and playing a third audible signal, different from the first and second audible signal, at the time t seconds before the time when the vehicle will accelerate from the parked position. In another example, the method also includes playing through the speaker a third audible signal, different from the first and second audible signals, at the time when the vehicle will begin to accelerate. In another example, the method also includes detecting an object in the vehicle's environment, and the audible signal is played through the speaker based on information about the detected object. In another example, the method also includes determining a current location of the vehicle; determining whether pedestrians are likely to be present based on the current location of the vehicle; and determining a volume level for the audible signal based on whether pedestrians are likely to be present, and playing the audible signal includes playing the audible signal at the determined volume level.

Another aspect of the disclosure provides a method. The method includes maneuvering a vehicle, by one or more processors, in an autonomous driving mode; while maneuvering the vehicle in the autonomous driving mode, determining, by the one or more processors, a time when the vehicle will begin to decelerate; and playing through a speaker, by the one or more processors, a first audible signal at the time when the vehicle begins decelerating. In one example, the method also includes, while maneuvering the vehicle in the autonomous driving mode, determining, by the processor, a time when the vehicle will begin to accelerate and playing a second audible signal, different from the first audible signal, through the speaker at a time t seconds before the time when the vehicle will begin to accelerate.

A further aspect of the disclosure provides a system comprising one or more processors. The one or more processors are configured to maneuver a vehicle in an autonomous driving mode; while maneuvering the vehicle in the autonomous driving mode, determine a time when the vehicle will begin to accelerate; play a first audible signal through a speaker at a time t seconds before the time when the vehicle will begin to accelerate; while maneuvering the vehicle in the autonomous driving mode, determine a time when the vehicle will begin to decelerate; and play through the speaker a second audible signal, different from the first audible signal, at the time when the vehicle begins decelerating.

In one example, the first audible signal includes a sound which mimics sounds of an internal combustion engine accelerating. In another example, the first audible signal includes a sound that mimics sounds of a hybrid vehicle engine accelerating. In another example, the audible signal includes a sound that mimics sounds of an internal combustion engine decelerating. In another example, the one or more processors are further configured to determine a time when the vehicle will accelerate from a parked position and play a third audible signal, different from the first and second audible signals, at the time t seconds before the time when the vehicle will accelerate from a parked position. In another example, the one or more processors are further configured to play through the speaker a third audible signal, different from the first and second audible signals, at the time when the vehicle will begin to accelerate. In another example, the one or more processors are further configured to detect an object in the vehicle's environment, and the audible signal is played through the speaker based on the detected object. In another example, the one or more processors are further configured to determine a current location of the vehicle; determine whether pedestrians are likely to be present based on the current location of the vehicle; and determine a volume level for the audible signal based on whether pedestrians are likely to be present, and playing the audible signal includes playing the audible signal at the determined volume level.

Another aspect of the disclosure provides a system comprising one or more processors. The one or more processors are configured to maneuver a vehicle in an autonomous driving mode; while maneuvering the vehicle in the autonomous driving mode, determine a time when the vehicle will begin to decelerate; and play through a speaker, by the one or more processors, a first audible signal at the time when the vehicle begins decelerating. In another example, the one or more processors are further configured to while maneuvering the vehicle in the autonomous driving mode, determine a time when the vehicle will begin to accelerate and play a second audible signal, different from the first audible signal, through the speaker at a time t seconds before the time when the vehicle will begin to accelerate.

### BRIEF DESCRIPTION OF THE DRAWINGS

FIG. 1 is a functional diagram of a system in accordance with aspects of the disclosure.

FIG. 2 is an interior of an autonomous vehicle in accordance with aspects of the disclosure.

FIG. 3 is an exterior of an autonomous vehicle in accordance with aspects of the disclosure.

FIG. 4 is an example scenario in accordance with aspects of the disclosure.

FIG. 5 is another example scenario in accordance with aspects of the disclosure.

FIG. 6 is a further example scenario in accordance with aspects of the disclosure.

FIG. 7 is an example scenario in accordance with aspects of the disclosure.

FIG. 8 is another example scenario in accordance with aspects of the disclosure.

FIG. 9 is a further example scenario in accordance with aspects of the disclosure.

FIG. 10 is an example scenario in accordance with aspects of the disclosure.

FIG. 11 is a flow diagram in accordance with aspects of the disclosure.

### DETAILED DESCRIPTION

The present disclosure relates to enabling an autonomous vehicle operating in a self-driving mode to communicate information about what the vehicle is about to do or is currently doing. In an autonomous driving mode, the vehicle's control computer can typically plan what actions the vehicle is going to take a few seconds or more in advance of taking those actions. For example, the vehicle's computer may be able to determine that the vehicle will need to accelerate or decelerate before such a need actually arises. The vehicle may then communicate this intent audibly alerting any tertiary users. Although various visual signals may be used, the vehicle may play an audible signal through a speaker to indicate that the vehicle will accelerate or decelerate in t-seconds.

Internal combustion engines may automatically indicate the sound of deceleration, even at low speeds, through engine noise. However, electric vehicles, on the other hand, do not make deceleration sounds at low speeds so deceleration sounds may be especially important. Thus, the features described herein will be especially useful in electric vehicles, as these vehicles typically make little to no noise while accelerating or decelerating at low speed.

Because indicating the intent to decelerate may actually be confusing to tertiary users, the audible signal for deceleration may be played when the vehicle is actually decelerating, and not as an advance warning. In this regard, the communication system may be considered asymmetric as intent is communicated only for acceleration and not deceleration.

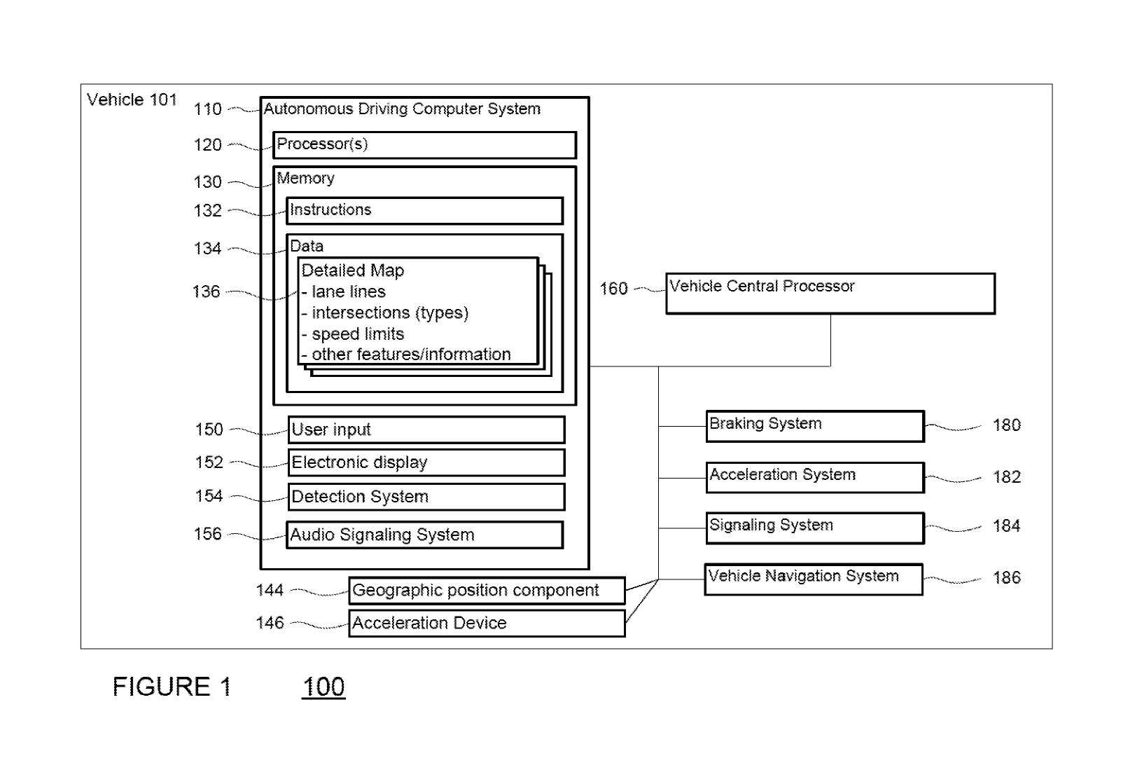

As shown in FIG. 1, an autonomous driving system 100 associated with an autonomous vehicle. In this regard, vehicle 101 may include an autonomous vehicle. While certain aspects of the disclosure are particularly useful in connection with specific types of vehicles, the vehicle may be any type of vehicle including, but not limited to, cars, trucks, motorcycles, busses, boats, airplanes, helicopters, lawnmowers, recreational vehicles, amusement park vehicles, farm equipment, construction equipment, trams, golf carts, trains, and trolleys. The vehicle may have one or more computers, such as computer 110 containing one or more processors 120, memory 130 and other components typically present in general purpose computers.

The memory 130 stores information accessible by the one or more processors 120, including instructions 132 and data 134 that may be executed or otherwise used by the one or more processors 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by the one or more processors 120 in accordance with the instructions 132. For instance, although the claimed subject matter is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The one or more processors 120 may be any conventional processors, such as commercially available CPUs. Alternatively, the processor may be a dedicated device such as an application-specific integrated circuit (“ASIC”) or other hardware-based processor. Although FIG. 1 functionally illustrates the processor, memory, and other elements of computer 110 as being within the same block, it will be understood by those of ordinary skill in the art that the processor, computer, or memory may actually comprise multiple processors, computers, or memories that may or may not be stored within the same physical housing. For example, memory may be a hard drive or other storage media located in a housing different from that of computer 110. Accordingly, references to a processor or computer will be understood to include references to a collection of processors or computers or memories that may or may not operate in parallel. Rather than using a single processor to perform the steps described herein, some of the components, such as steering components and deceleration components, may each have their own processor that only performs calculations related to the component's specific function.

In various aspects described herein, the one or more processors may be located remote from the vehicle and communicate with the vehicle wirelessly. In other aspects, some of the processes described herein are executed on a processor disposed within the vehicle and others by a remote processor, including taking the steps necessary to execute a single maneuver.

Computer 110 may include all of the components normally used in connection with a computer such as a central processing unit (CPU) or other processors, memory (e.g., RAM and internal hard drives) storing data 134 and instructions such as a web browser, an electronic display 152 (e.g., a monitor having a screen, a small LCD touch-screen or any other electrical device that is operable to display information), user input 150 (e.g., a mouse, keyboard, touch screen and/or microphone), as well as various sensors (e.g., a video camera) for gathering explicit (e.g., a gesture) or implicit (e.g., “the person is asleep”) information about the states and desires of a person.

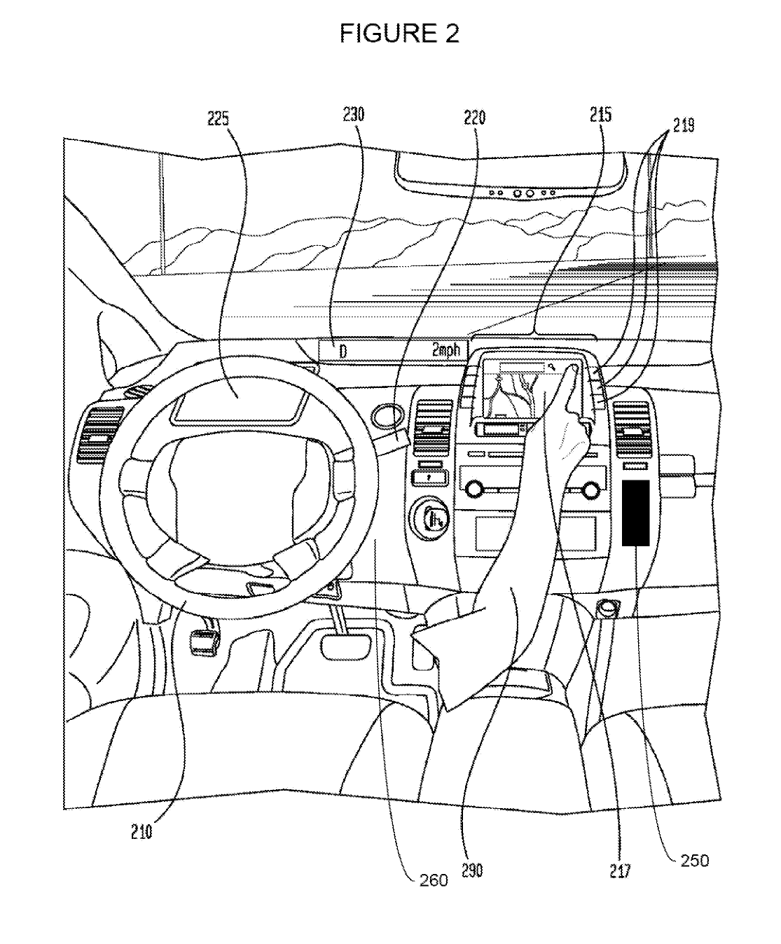

In one example, computer 110 may be an autonomous driving computing system incorporated into vehicle 101. FIG. 2 depicts an exemplary design of the interior of an autonomous vehicle. The autonomous vehicle may include all of the features of a non-autonomous vehicle, for example: a steering apparatus, such as steering wheel 210; a navigation display apparatus, such as navigation display 215 (which may be a part of electronic display 152); and a gear selector apparatus, such as gear shifter 220. The vehicle may also have various user input devices 140 in addition to the foregoing, such as touch screen 217 (which may be a part of electronic display 152), or button inputs 219, for activating or deactivating one or more autonomous driving modes and for enabling a driver or passenger 290 to provide information, such as a navigation destination, to the autonomous driving computer 110.

The autonomous driving computing system may be capable of communicating with various components of the vehicle. For example, returning to FIG. 1, computer 110 may be in communication with the vehicle's central processor 160 and may send and receive information from the various systems of vehicle 101, for example the braking system 180, acceleration system 182, signaling system 184, and navigation system 186 in order to control the movement, speed, etc. of vehicle 101. In one example, the vehicle's central processor 160 may include one or more processors configured to perform all of the functions of the various processors in vehicles that do not include fully autonomous driving modes. In another example, the one or more processors 120 and 160 may comprise a single processing device or multiple processing devices operating in parallel.

In addition, when engaged, computer 110 may control some or all of the maneuvering functions of vehicle 101 and thus be fully or partially autonomous. Although various systems and computer 110 are shown within vehicle 101, these elements may be external to vehicle 101 or physically separated by large distances.

The vehicle may also include a geographic position component 144 in communication with computer 110 for determining the geographic location of the device. For example, the position component may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it, which can often be determined with better accuracy than absolute geographical location.

The vehicle may also include other devices in communication with computer 110, such as an accelerometer, gyroscope or another direction/speed detection device 146 to determine the direction and speed of the vehicle or changes thereto. By way of example only, acceleration device 146 may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the user, computer 110, other computers and combinations of the foregoing.

The computer 110 may control the direction and speed of the vehicle by controlling various components. By way of example, if the vehicle is operating in a completely autonomous driving mode, computer 110 may cause the vehicle to accelerate (e.g., by increasing fuel or other energy provided to the engine), decelerate (e.g., by decreasing the fuel supplied to the engine or by applying brakes) and change direction (e.g., by turning the front two wheels).

The vehicle may also include components for detecting objects external to the vehicle such as other vehicles, obstacles in the roadway, traffic signals, signs, trees, etc. The detection system 154 may include lasers, sonar, radar, cameras or any other detection devices which record data which may be processed by computer 110. As an example, the cameras may be mounted at predetermined distances so that the parallax from the images of two or more cameras may be used to compute the distance to various objects.

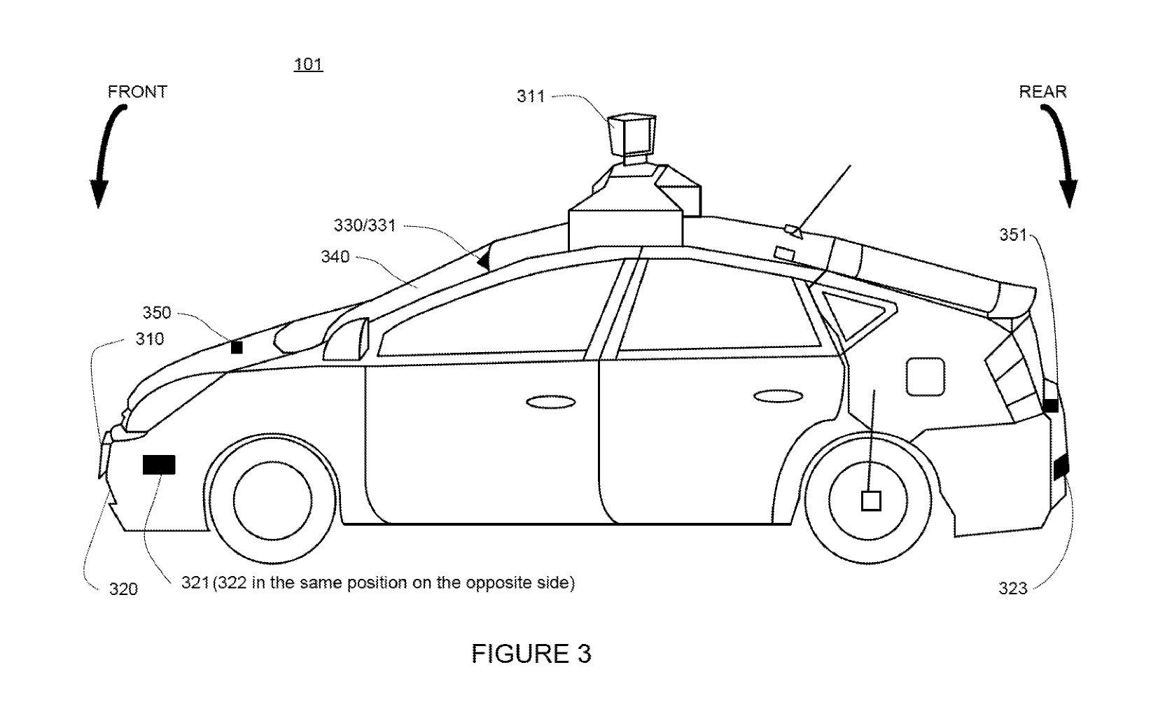

If the vehicle is a small passenger vehicle, the vehicle may include various sensors mounted on the roof or at other convenient location. As shown in FIG. 3, vehicle 101 may include a small passenger vehicle having lasers 310 and 311, mounted on the front and top of the vehicle, respectively. Vehicle 101 also includes radar detection units 320-323 located on the side (only one side being shown), front and rear of the vehicle. Vehicle 101 includes two cameras 330-331 mounted under a windshield 340 near the rear view mirror (not shown). Camera 330 may include a range of approximately 200 meters and an approximately 30 degree horizontal field of view, while camera 331 may include a range of approximately 100 meters and an approximately 60 degree horizontal field of view.

The vehicle's cameras may be configured to send and receive information directly or indirectly with the vehicle's autonomous driving system. For example, camera 330 and/or 331 may be hard wired to computer 110 or may send and receive information with computer 110 via a wired or wireless network of vehicle 101. Camera 330 and/or 331 may receive instructions from computer 110, such as image setting values, and may provide images and other information to computer 110. Each camera may also include a processor and memory configured similarly to processor 120 and memory 130 described above.

In addition to the sensors described above, the one or more computers may also use input from other sensors and features typical to non-autonomous vehicles. For example, these other sensors and features may include tire pressure sensors, engine temperature sensors, brake heat sensors, break pad status sensors, tire tread sensors, fuel sensors, oil level and quality sensors, air quality sensors (for detecting temperature, humidity, or particulates in the air), door sensors, lights, wipers, etc. This information may be provided directly from these sensors and features or via the vehicle's central processor 160.

Many of these sensors provide data that is processed by one or more computers in real-time, that is, the sensors may continuously update their output to reflect the environment being sensed at or over a range of time, and continuously or as-demanded provide that updated output to the computer so that the computer can determine whether the vehicle's then-current direction or speed should be modified in response to the sensed environment.

In addition to processing data provided by the various sensors, the one or more computers may rely on environmental data that was obtained at a previous point in time and is expected to persist regardless of the vehicle's presence in the environment. For example, returning to FIG. 1, data 134 may include detailed map information 136, e.g., highly detailed maps identifying the shape and elevation of roadways, lane lines, intersections, crosswalks, speed limits, traffic signals, buildings, signs, real time traffic information, vegetation, or other such objects and information.

The map information may also include three-dimensional terrain maps incorporating one or more of objects listed above. For example, the vehicle may determine that another object, such as a vehicle, is expected to turn based on real-time data (e.g., using its sensors to determine the current GPS position of another vehicle and whether a turn signal is blinking) and other data (e.g., comparing the GPS position with previously-stored lane-specific map data to determine whether the other vehicle is within a turn lane).

Although the detailed map information 136 is depicted herein as an image-based map, the map information need not be entirely image based (for example, raster). For example, the map information may include one or more roadgraphs or graph networks of information such as roads, lanes, intersections, and the connections between these features. Each feature may be stored as graph data and may be associated with information such as a geographic location whether or not it is linked to other related features. For example, a stop sign may be linked to a road and an intersection. In some examples, the associated data may include grid-based indices of a roadgraph to promote efficient lookup of certain roadgraph features.

The computer 110 may also communicate with an audio signaling system 156 (shown in FIG. 1). The audio signaling system may provide audible signals within and outside of vehicle 101. The audio signaling system may include one or more conventional speakers or other devices for providing audible signals to passengers of vehicle 101 or to tertiary users. These speakers may be an integral part of vehicle 101, such as a speaker of a sound system of a typical vehicle, or a specialized speaker which produces only the intent to accelerate, acceleration, intent to decelerate, or deceleration audible signals described herein. For example as shown in FIG. 2, an internal speaker 250 may be incorporated into or attached to the dashboard 260 of vehicle 101.

In addition to the operations described above and illustrated in the figures, various operations will now be described. It should be understood that the following operations do not have to be performed in the precise order described below. Rather, various steps can be handled in a different order or simultaneously, and steps may also be added or omitted.

In the autonomous driving mode, the vehicle's one or more computers can typically plan what actions the vehicle is going to take a few seconds or more in advance of taking those actions. For example, the vehicle's computer may be able to determine that the vehicle will need to accelerate or decelerate before such a need actually arises. This may occur simply because of the requirements of a particular route to a destination as well as the characteristics of intersections, traffic signals, other vehicles, other objects or obstacles in a roadway, weather conditions, etc. For example, the vehicle's one or more computers may perform a planning function that serves to plot the vehicle's future speed and trajectory curve based on the world as it perceives it. Therefore, the vehicle's computer is able to automatically and precisely exactly determine when the vehicle will accelerate or decelerate in the future.

The vehicle may communicate this information, alerting the “driver” (the person who will drive when the car is not in autonomous mode), other passengers of the vehicle, and tertiary users. Various visual signals may be used to communicate this information. For example, images may be projected on the ground towards the front, side, or back of the vehicle with text or symbols indicating that the vehicle will or is accelerating or decelerating. In addition, or alternatively, this information may be rendered on displays positioned at various locations on the vehicle. Lights may also be used to signal intent by flashing them at different rhythms, increasing or decreasing in speed, etc. For example, information may be provided using new lighting on the front, side, and/or rear of the vehicle and/or using existing lights.

The vehicle may also communicate what the vehicle is or will be doing audibly. For example, the vehicle's one or more computers may play an audible signal through a speaker to indicate that the vehicle will accelerate or decelerate in t-seconds. As an example only, the value of t may range from 0.5 seconds to 1.5 seconds or more. This technique will be especially useful in electric vehicles, as these vehicles typically make little to no noise while accelerating or decelerating at low speed.

The future acceleration audible signal, for example when the vehicle will accelerate in the near future, may notify nearby tertiary users that the vehicle will begin to accelerate shortly unless conditions change. Examples of such changes may include where the pedestrian steps in front of the vehicle, the pedestrian was unseen until later, a car in front of the vehicle slowed unexpectedly, etc. The audible signal warns those nearby that the vehicle is about to move. As an example, when this sound is used in conjunction with traditional turn signals, the pedestrians, bicyclists or human drivers of other vehicles may also receive additional information about vehicle trajectory.

Because indicating that the vehicle will begin to decelerate in the future may actually be confusing to tertiary users, the audible signal for deceleration may be played when the vehicle is actually decelerating, and not as an advance warning. That is, if the tertiary user overestimates the timing of deceleration, that might cause a pedestrian to falsely step in front of a vehicle. Acceleration, on the other hand, can generally be safely communicated in advance of movement. This advance warning may provide tertiary users with sufficient time to reach or make any necessary decisions. In this regard, the communication system may be considered asymmetric as what the vehicle will do in the future is communicated only for acceleration and not deceleration.

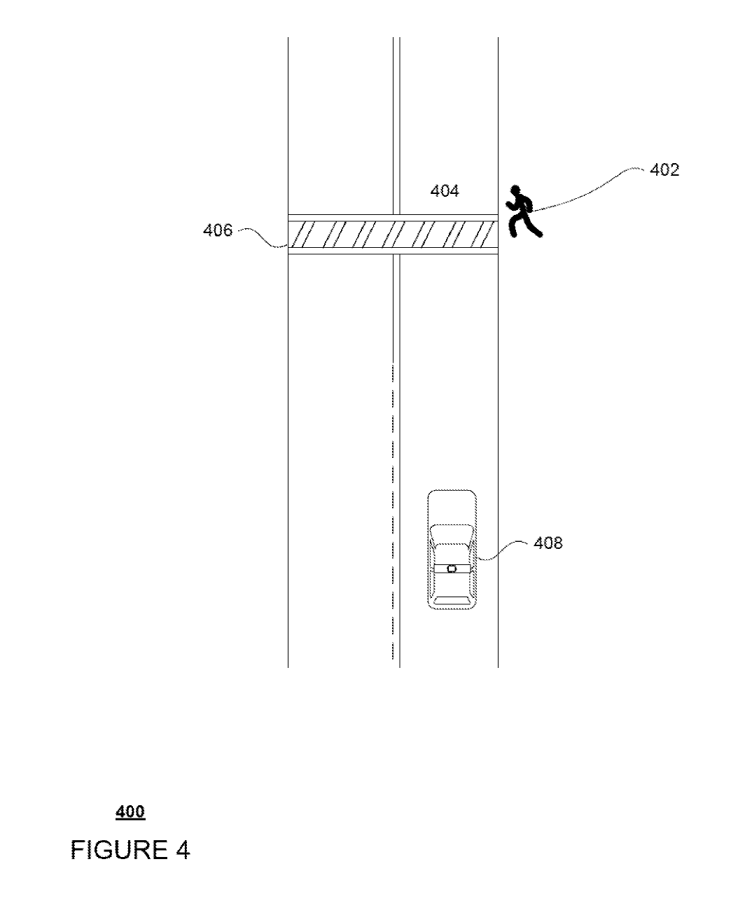

The FIGS. 4-11 are examples where the aforementioned signals may be useful. In example 400 of FIG. 4, a pedestrian 402 may plan to cross the roadway 404 at crosswalk 406. Vehicle 408 is also approaching the crosswalk 406. The pedestrian may not be able to determine whether the vehicle will yield to the pedestrian or continue through the crosswalk 406. If vehicle 408 were vehicle 101, the computer 110 may determine that the vehicle 101 will stop at the crosswalk 406 either because the detailed map information indicates that a stop is required or because the computer 110 has identified the pedestrian 402. Accordingly, computer 110 may play an audible signal to indicate that the vehicle 101 is slowing down. The sound may assist the pedestrian 402 in noticing when vehicle 408 is slowing down.

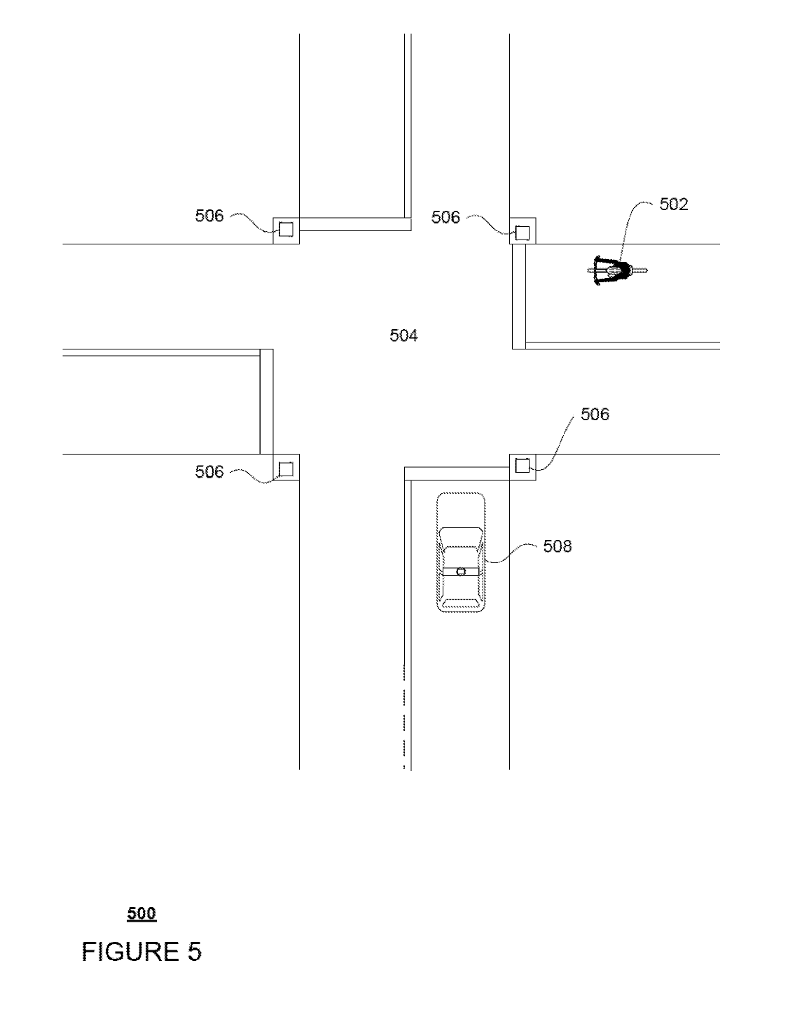

In example 500 of FIG. 5, a bicyclist 502 is at or coming to an intersection 504 with a stop sign 506 on each corner, a four-way stop. A vehicle 508 is also stopped at one of the stop signs. The bicyclist may not be able to determine whether the vehicle will yield to the bicyclist or continue through the intersection 504. If the vehicle 508 is vehicle 101, the computer 110 may determine that the vehicle 101 will accelerate. In this way, the computer 110 may play an audible signal t seconds before the vehicle 101 will begin to accelerate, to indicate that the vehicle 101 will accelerate, or in other words, not yield the right-of-way to the bicyclist.

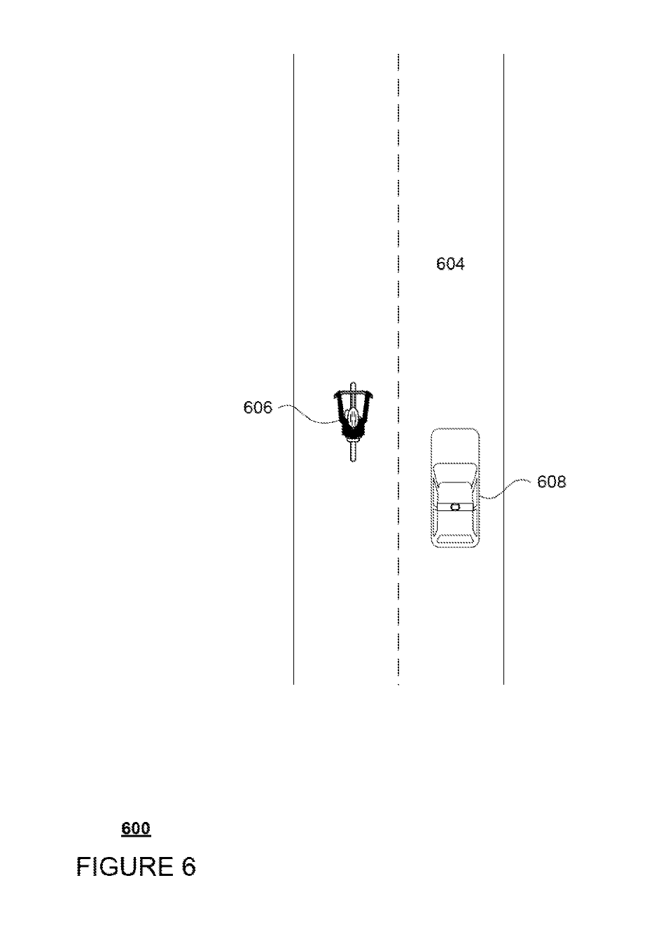

In example 600 of FIG. 6, a bicyclist 602 is riding alongside a vehicle 604 and wants to merge into lane 606. The vehicle 604 begins to slow down. The bicyclist may make the assumption that the vehicle is slowing to let the bicyclist merge. If the vehicle 604 then begins to accelerate, the bicyclist may be caught off guard. Again, if the vehicle 604 is vehicle 101, the computer 110 may determine that the vehicle 101 will accelerate. The computer 110 may play an audible signal t seconds before the vehicle 101 will begin to accelerate, to indicate that the vehicle 101 will accelerate. Thus, the bicyclist may quickly determine that the vehicle 101 is not yielding to the bicyclist.

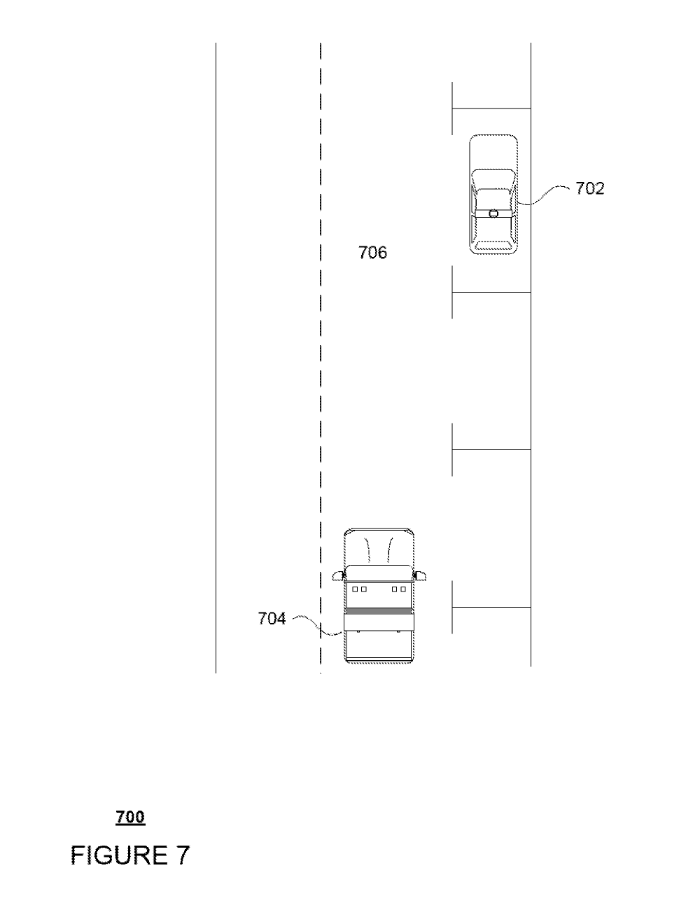

In example 700 of FIG. 7, a vehicle 702 is idling in a parked position with an activated left turn signal. Without some signal from the driver, a tertiary user, such as the human driver of vehicle 704, has no way of knowing when the vehicle 702 will pull out into the roadway 706 until the instant the vehicle starts to do so. Again, if the vehicle 702 is vehicle 101, the computer 110 may determine that the vehicle 101 will accelerate from the parked position. The computer 110 may play an audible signal t seconds before the vehicle 101 will begin to accelerate from the parked position, to indicate that the vehicle 101 will accelerate and move into roadway 706. Thus, the human driver of vehicle 704 may quickly determine that the vehicle 101 is going to move into the roadway 706 immediately.

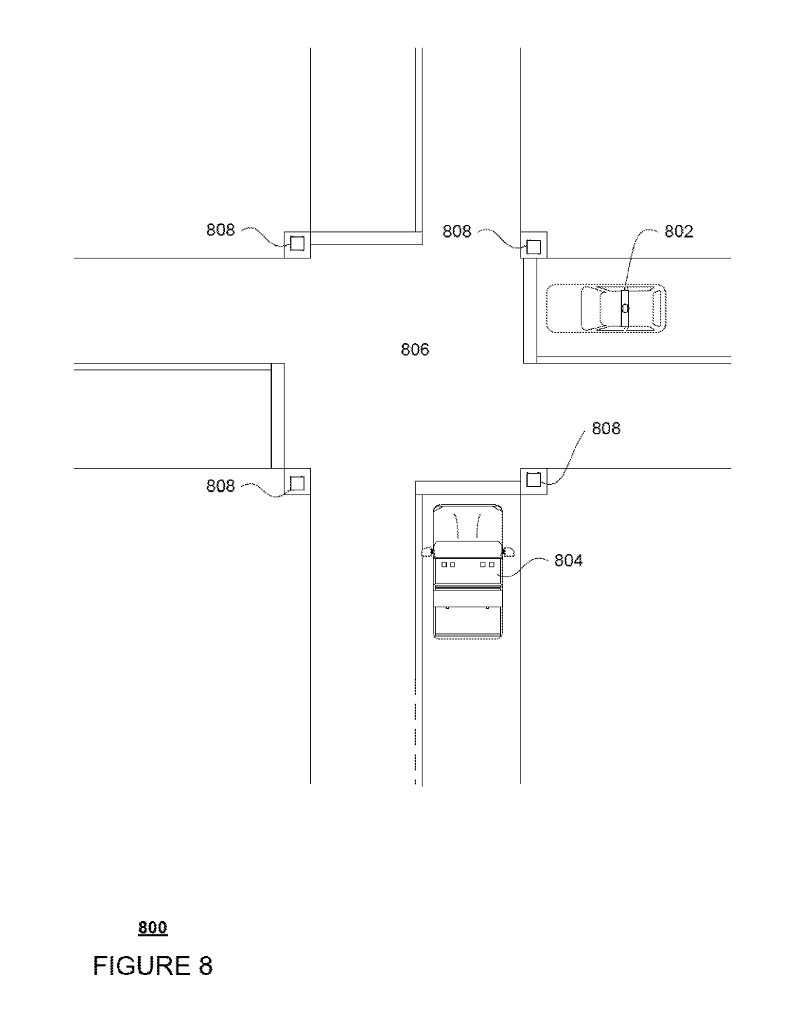

In example 800 of FIG. 8, vehicles 802 and 804 may arrive at stop signs on different corners of an intersection 506 with a stop sign 508 on each corner at approximately the same time. Again, without some signal from the drivers, neither will know which should move through the intersection first. However, if one of vehicles 802 and 804 are vehicle 101, rather than waiting for a signal from the other vehicle, vehicle 101 may provide an audible signal to indicate that vehicle 101 will move through the intersection 806. In this way, the computer 110 may play an audible signal t seconds before the vehicle 101 will begin to accelerate into the intersection 806 in order to notify the driver of vehicle 804. In this way, if vehicle 804 begins to accelerate first, vehicle 101 may still have time to yield.

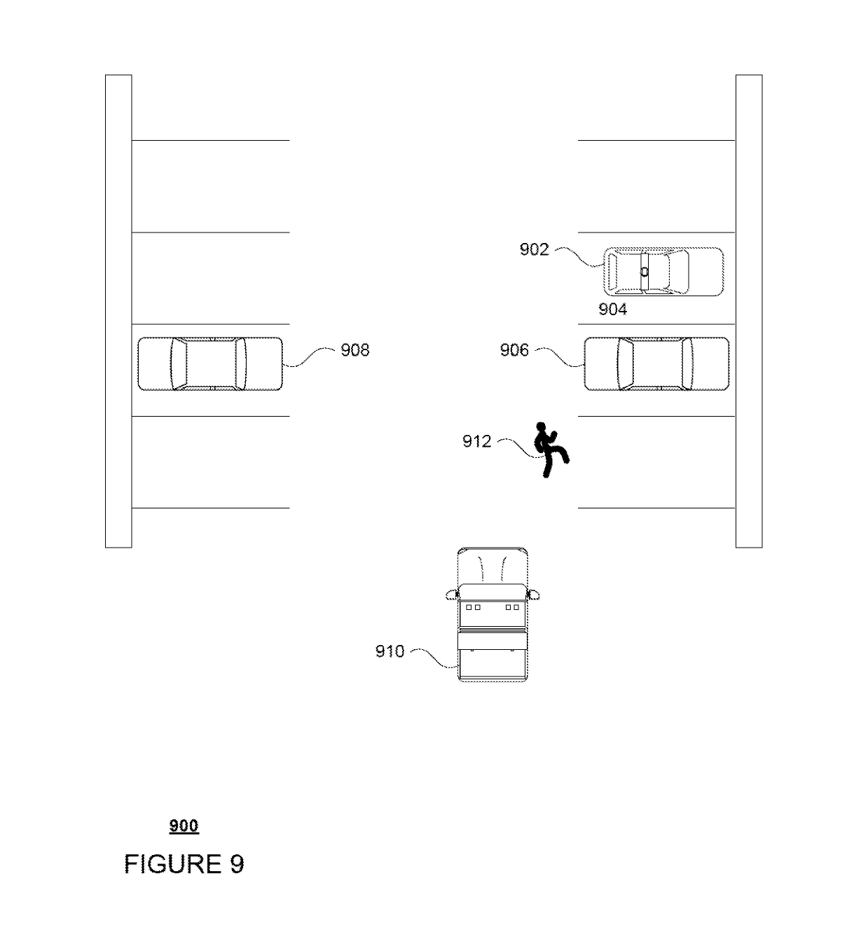

In example 900 of FIG. 9, vehicle 902 may move into reverse, for example, to back out of a parking spot 904. If vehicle 902 is a typical vehicle tertiary users may not be given any warning as to when the vehicle is going to move. Even if there is a “reverse alert” that triggers when the vehicle is put into reverse, tertiary users will still not know when the car is about to move; it could be a few seconds or even minutes after the vehicle is put into reverse. This can lead to a “false alarm” situation which leads to dangerous behavior in the long run as people do not trust the alert and try to cross the path of the vehicle. Again, if the vehicle 902 is vehicle 101, the computer 110 may determine that the vehicle 101 will accelerate from the parked position. The computer 110 may play an audible signal t seconds before the vehicle 101 will begin to back out of the parking spot 904, to indicate that the vehicle 101 will begin moving out of the parking spot. Thus, tertiary users 906, 908, 910, and 912 in the area will be able to recognize that vehicle 101 will be backing out of the parking spot 904.

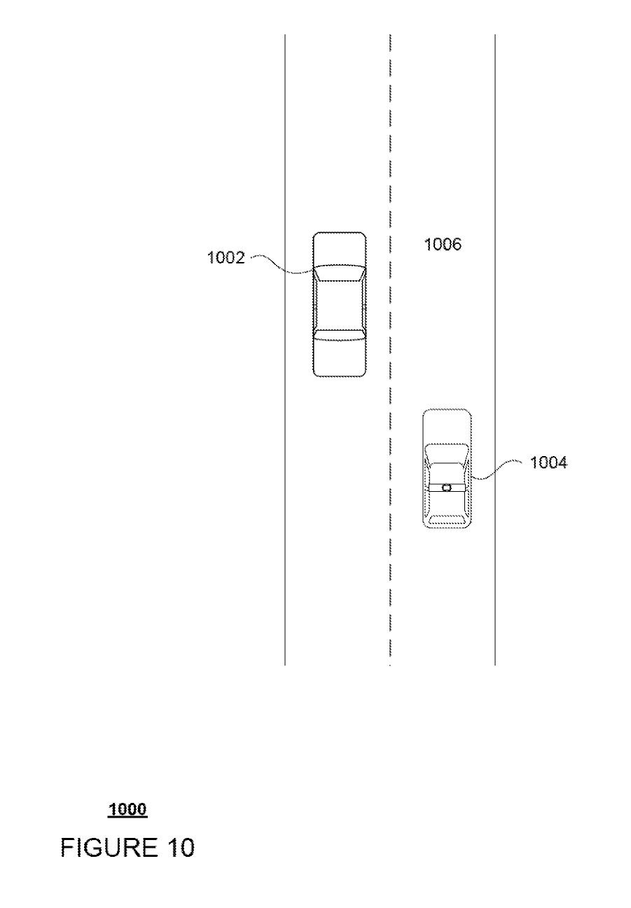

Example 1000 of FIG. 10 is similar to the example 500 described above. In example 1000, a vehicle 1002 is driving alongside a vehicle 1004 and wants to merge into lane 1006. Vehicle 1004 may begin to slow down. The human driver of vehicle 1002 may make the assumption that vehicle 1004 is slowing to let vehicle 1002 merge but in fact vehicle 1004 is slowing for another reason and actually will begin to accelerate shortly. If the vehicle 1004 is vehicle 101, the computer 110 may determine that the vehicle 101 will accelerate. In this way, the computer 110 may play an audible signal t seconds before the vehicle 101 will begin to accelerate, to indicate that the vehicle 101 will accelerate. Accordingly, the driver of vehicle 1002 may realize that it is not appropriate to merge into lane 1006.

With each of the above examples, if the tertiary user or users were informed that the vehicle was going to accelerate, decelerate, or stay at the same speed, this would be helpful information which could improve safety in an autonomous vehicle such as vehicle 101. In examples 400, 600, and 1000 above, decelerate signal that indicates that the vehicle will decelerate in the future may lead to dangerous behavior. However, in the examples of 500, 700, 800, and 900 as the vehicle is already stopped, no such issue would arise.

The audible signals described above may take various forms. For example, the audible signal may be a single chime or note with different pitches for acceleration or deceleration, patterns of chime or notes, or sounds that mimics the sounds of an internal combustion or hybrid engine. In addition, the audible signal may include music or other non-mechanical sounds which unambiguously suggest acceleration or deceleration. The audible signals for future acceleration, future deceleration, currently accelerating, and currently decelerating may take any number of the aforementioned forms.

One challenge with communicating information to tertiary users is the clarity of message: who is the message for and what specifically does it mean? When a typical internal combustion engine vehicle is decelerating, the engine sounds change to lesser volume and lower pitch. A constant velocity may also be associated with constant engine sounds, and when a vehicle is accelerating, the engine sounds may become louder and have a higher pitch. By using this universally understood signal, where an increased volume and pitch are associated with an increase in speed and a decreased volume and pitch are associated with a decrease in speed, tertiary users may be able to quickly and easily understand the message. As another example, the audible signal to indicate that the vehicle will accelerate in the future could be a series of bell tones that becomes more frequent and/or louder as the time for acceleration comes closer or the vehicle accelerates.

In some examples, the audible signals may mimic the sounds of an internal combustion engine or hybrid engine. Thus, when the vehicle is decelerating, the vehicle's computer may play sounds that mimic the sounds of an internal combustion or hybrid engine decelerating. Similarly, the audible signal for future acceleration may also mimic the acceleration sounds of an internal combustion or hybrid engine.

In addition, for acceleration, there may be one audible signal for when the vehicle is moving from a previously parked position, a second audible signal for future acceleration when the vehicle is currently moving, and a third audible signal when the vehicle is actually accelerating. The same sound may also be used for both future acceleration as well as actual acceleration, but this may be confusing to tertiary users as the vehicle would sound like the vehicle is accelerating when the vehicle actually is not.

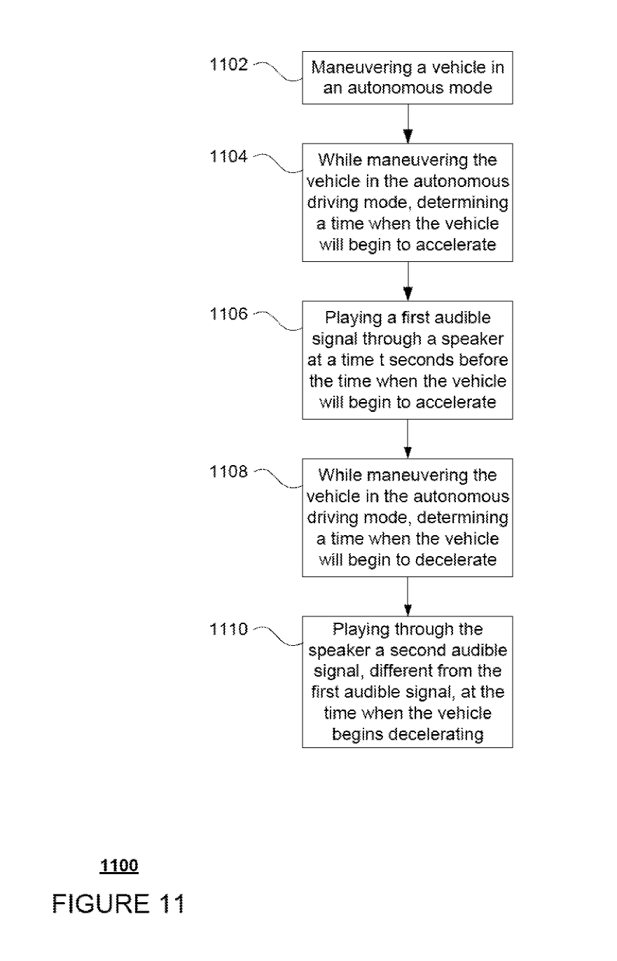

Flow diagram 1100 of FIG. 11 is an example of some of the aspects and features described above which may be performed, for example, by one or more computers such as computer 110 of vehicle 101. In this example, computer 110 may maneuver vehicle 101 in an autonomous driving mode at block 1102. While maneuvering the vehicle in the autonomous driving mode, a time when the vehicle will begin to accelerate is determined at block 1104. A first audible signal is played through a speaker at a time t seconds before the time when the vehicle will begin to accelerate at block 1106. While maneuvering the vehicle in the autonomous driving mode, a time when the vehicle will begin to decelerate is determined at block 1108. A second audible signal, different from the first audible signal, at the time when the vehicle begins decelerating is played through the speaker at block 1110.

The features described above may also be used differently in different situations. For example, the acceleration warning sound may be used only in situations where the vehicle actually detects other objects such as pedestrians or bicyclists. Such use may be advantageous in that the audible signals will only be played when necessary, but may be disadvantageous in that the vehicle would not play a sound in the unlikely event that a pedestrian or cyclist is not detected. In some examples, the sound produced may be directional. For example, the sound may be placed in the direction that pedestrians, bicyclists, or other vehicles are detected or are likely to be, for example, according to the detailed map information. The audible signals may also be played louder in situations or locations where pedestrians are expected to be, such as in school zones, busy intersections, etc.

In addition to playing sounds to provide information to pedestrians, bicyclists, and other drivers, the features described above may be used to provide information directly to the computers of other vehicles. Various vehicle to vehicle communication technologies may be used to send messages regarding the future acceleration or deceleration to other autonomous or non-autonomous vehicles. This may provide an advantage where a human driver of a non-autonomous vehicle, or a vehicle operating in a manual mode, would be unable to hear the sounds played through speakers, such as where the windows are rolled up, etc. The receiving vehicles' computers may then manifest this information to the corresponding driver using visual, audible, or haptic cues.

In addition, or as an alternative to, vehicle to vehicle communications, other methods of notifying pedestrians, bicyclists, or other human drivers may also be used. For example, acceleration or deceleration warning messages may be sent to persons on their mobile computing devices, such as a cellular phone, who have signed up for such a service. The messages may be communicated using near-field or other communication methods. The mobile computing device may then communicate the messages using vibration, text messages, and/or audio signals. The type of signal may depend upon what the person is currently doing: vibration if the mobile communication device is in a pocket, text message if the person is texting, audible if the person is on a call, etc. This could be helpful to the hearing impaired, the elderly, or other people who signed up for the service.

The features described herein are useful for autonomous vehicles as they are able to utilize a future-looking sound without interfering with driving behavior. For instance, if a traditional vehicle required the sound level to change for t seconds before acceleration, one of two things would have to happen: a) the driver would not be able to quickly accelerate, leading to an unpleasant driving experience and potentially unsafe conditions or b) the driver would have to self-initiate an alarm exactly t seconds before accelerating, much as a human train engineer may do, which may be too unreliable for a typical human driver.

As noted above, vehicles operating in an autonomous driving mode have an enormous advantage over non-autonomous vehicles when it comes to indicating what the vehicle will do in the future: the vehicle 101's one or more computers may know when the vehicle will accelerate, decelerate (including stop), or maintain speed because of the planning function of the vehicle's one or more computers. Thus, it becomes possible for the vehicle 101's one or more computer to automatically indicate what it intends to do.

As these and other variations and combinations of the features discussed above can be utilized without departing from the subject matter as defined by the claims, the foregoing description of exemplary embodiments should be taken by way of illustration rather than by way of limitation of the subject matter as defined by the claims. It will also be understood that the provision of the examples described herein (as well as clauses phrased as “such as,” “e.g.”, “including” and the like) should not be interpreted as limiting the claimed subject matter to the specific examples; rather, the examples are intended to illustrate only some of many possible aspects.

1. A method comprising:
maneuvering a vehicle, by one or more processors, in an autonomous driving mode;
while maneuvering the vehicle in the autonomous driving mode, determining, by the one or more processors, a time when the vehicle will begin to accelerate;
beginning to play, by the one or more processors, a first audible signal through a speaker at a time t seconds before the determined time in the future when the vehicle will begin to accelerate, where t is greater than 0, wherein the first audible signal is played such that a first object in the vehicle's external environment is provided with an indication that the vehicle intends to accelerate;
while maneuvering the vehicle in the autonomous driving mode, determining, by the one or more processors, a time in the future when the vehicle will begin to decelerate; and
beginning to play, by the one or more processors, through the speaker a second audible signal, different from the first audible signal, at a time when the vehicle begins decelerating based on the determined time in the future when the vehicle will begin to decelerate, wherein the second audible signal is played such that a second object in the vehicle's external environment is provided with an indication that the vehicle is currently decelerating.

2. The method of claim 1, wherein the first audible signal includes a sound that mimics sounds of an internal combustion engine accelerating.

3. The method of claim 1, wherein the first audible signal includes a sound which mimics sounds of a hybrid vehicle engine accelerating.

4. The method of claim 1, wherein the audible signal includes a sound that mimics sounds of an internal combustion engine decelerating.

5. The method of claim 1, further comprising:
determining a time in the future when the vehicle will accelerate from a parked position in a parking spot; and
beginning to play a third audible signal, different from the first and second audible signals, at a time t seconds before the time in the future when the vehicle will accelerate from the parked position, wherein the third audible signal is played such that a third object in the vehicle's external environment is provided with an indicate that the vehicle intends to accelerate from the parked position.

6. (canceled)

7. The method of claim 1, further comprising detecting the first object in the vehicle's external environment, wherein the first audible signal is played through the speaker based on information about the first object.

8. The method of claim 1, further comprising:
determining a current location of the vehicle;
determining whether pedestrians are likely to be present based on the current location of the vehicle; and
determining a volume level for the audible signal based on whether pedestrians are likely to be present, wherein playing the first audible signal includes playing the audible signal at the determined volume level.

9. (canceled)

10. (canceled)

11. A system comprising one or more processors configured to:
maneuver a vehicle in an autonomous driving mode;
while maneuvering the vehicle in the autonomous driving mode, determine a time in the future when the vehicle will begin to accelerate;
begin to play a first audible signal through a speaker at a time t seconds before the determined time in the future when the vehicle will begin to accelerate, where t is greater than 0, wherein the first audible signal is played such that a first object in the vehicle's external environment is provided with an indication that the vehicle intends to accelerate;
while maneuvering the vehicle in the autonomous driving mode, determine a time in the future when the vehicle will begin to decelerate; and
begin to play through the speaker a second audible signal, different from the first audible signal, at a time when the vehicle begins decelerating based on the determined future time when the vehicle will begin to decelerate, wherein the second audible signal is played such that a second object in the vehicle's external environment is provided with an indication that the vehicle is currently decelerating.

12. The system of claim 11, wherein the first audible signal includes a sound which mimics sounds of an internal combustion engine accelerating.

13. The system of claim 11, wherein the first audible signal includes a sound that mimics sounds of a hybrid vehicle engine accelerating.

14. The system of claim 11, wherein the audible signal includes a sound that mimics sounds of an internal combustion engine decelerating.

15. The system of claim 13, wherein the one or more processors are further configured to:
determine a time in the future when the vehicle will accelerate from a parked position in a parking spot; and
play a third audible signal, different from the first and second audible signals, at a time t seconds before the determined time in the future when the vehicle will accelerate from a parked position, wherein the third audible signal is played such that a third object in the vehicle's external environment is provided with an indicate that the vehicle intends to accelerate from the parked position.

16. (canceled)

17. The system of claim 13, wherein the one or more processors are further configured to detect an object in the vehicle's external environment, wherein the first audible signal is played through the speaker based on the first object.

18. The system of claim 13, wherein the one or more processors are further configured to:
determine a current location of the vehicle;
determine whether pedestrians are likely to be present based on the current location of the vehicle; and
determine a volume level for the audible signal based on whether pedestrians are likely to be present, wherein playing the first audible signal includes playing the audible signal at the determined volume level.

19. (canceled)

20. (canceled)

21. The method of claim 1, wherein determining the time when the vehicle will begin to accelerate when the vehicle is approaching a traffic intersection.

22. The method of claim 1, wherein determining the time when the vehicle will begin to accelerate when the vehicle is stopped at a stop sign.

23. The system of claim 11, wherein the one or more processors are further configured to determine the time when the vehicle will begin to accelerate when the vehicle is approaching a traffic intersection.

24. The system of claim 1, wherein the one or more processors are further configured to determine the time when the vehicle will begin to accelerate when the vehicle is stopped at a stop sign.
